(19) United States
(12) Patent Application Publication
(10) Pub. No.: US 2012/0098763 A1
(43) Pub. Date: Apr. 26, 2012

(54) ELECTRONIC READER AND NOTATION METHOD THEREOF

(75) Inventor: WEI SONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/092,161

(22) Filed: Apr. 22, 2011

(30) Foreign Application Priority Data
Oct. 20, 2010 (CN) 201010513197.0

(51) Int. Cl. G06F 3/041

(52) U.S. Cl. 345/173

(57) ABSTRACT

An electronic reader includes an input unit, a storage unit and a processing unit. The processing unit configured to display a page of a file stored in the storage unit, determine whether the touch track is analogous to the preset symbol, display an input box beside the touch track to receive content of a notation if the touch track is analogous to the preset symbol, store the content of the notation in the storage unit and show the notation symbol at a vertex position of the touch track to replace the touch track to indicate the notation. A notation method is also provided.

### BACKGROUND

1. Technical Field

The present disclosure relates to electronic readers and, particularly, to an electronic reader and a method for notation thereof.

2. Description of the Related Art

Often a time, when adding a notation to a page of a file displayed on an electronic reader, a user need to select the notation option in a menu to enter notation mode, and further select a position on the page where the user wants to place the notation. This method is cumbersome and inconvenient, particularly if the user wants to make many notations.

### BRIEF DESCRIPTION OF THE DRAWINGS

The components of the drawings are not necessarily drawn to scale, the emphasis instead being placed upon clearly illustrating the principles of an electronic reader and a notation-adding method thereof.

Moreover, in the drawings, like reference numerals designate corresponding parts throughout multiple views.

FIG. 1 is a schematic view of an electronic reader displaying a notation-adding interface in accordance with an exemplary embodiment.

FIG. 2 is a block diagram of the electronic reader of FIG. 1.

FIG. 3 is a schematic view of an electronic reader of FIG. 1, displaying a notated page.

FIG. 4 is a flowchart of a notation-adding method applied in the electronic reader of FIG. 1 in accordance with an exemplary embodiment.

FIG. 5 is a flowchart of a notation-revealing method applied in the electronic reader of FIG. 4.

### DETAILED DESCRIPTION

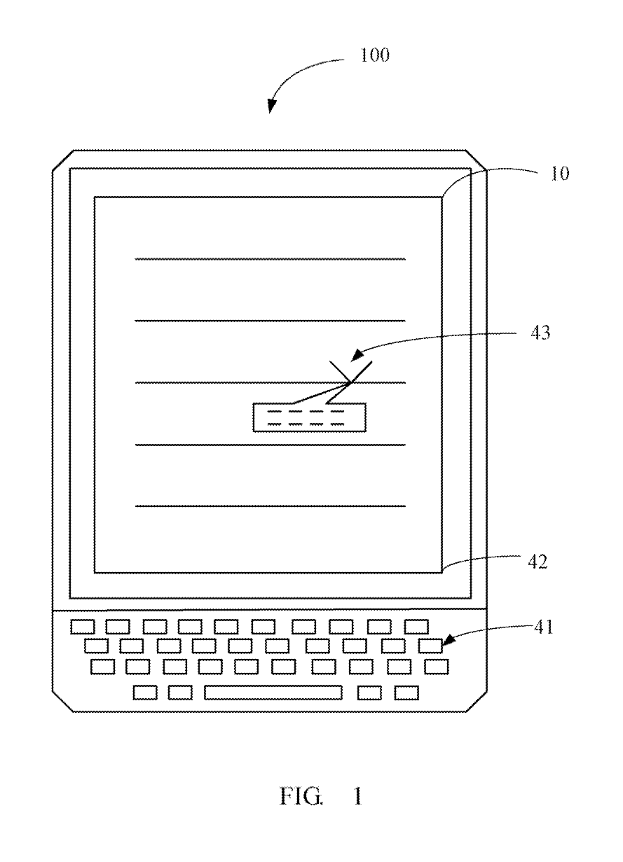

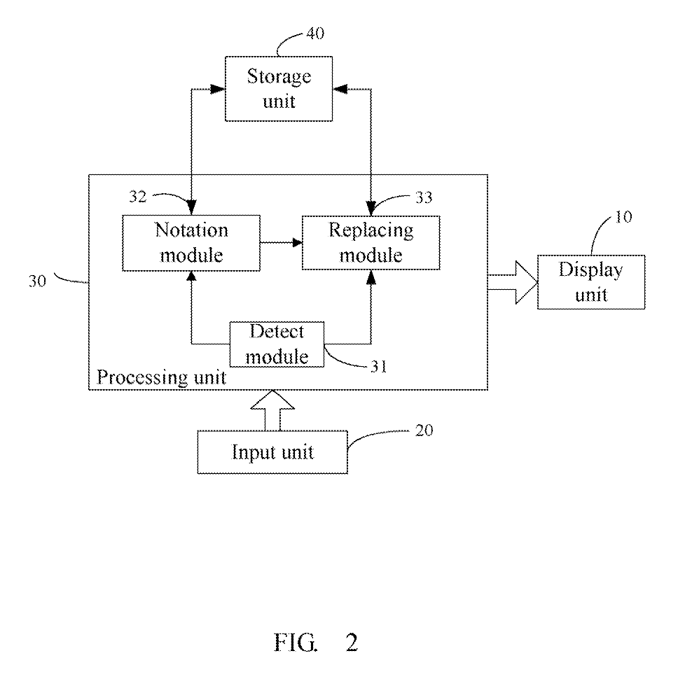

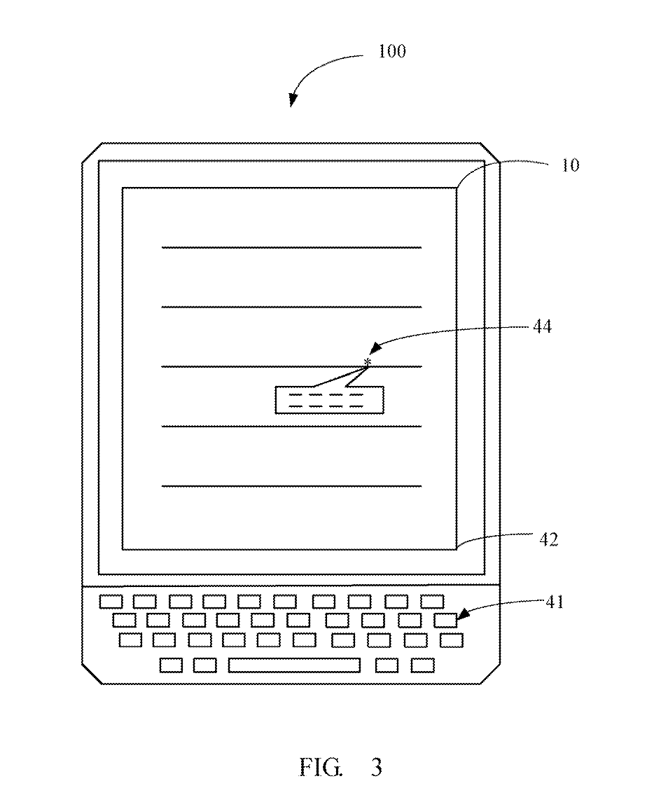

Referring to FIGS. 1-3, an electronic reader 100 includes a display unit 10, an input unit 20, a processing unit 30, and a storage unit 40. The storage unit 40 is configured to store files and a notation symbol 44 for notations in the files. The notation symbol 44 may be a symbol or a small icon, such as the symbol “*”. The input unit 20 includes a touch panel 42, and the touch panel 42 is configured to generate touch signals in response to input operations. The touch panel 42 cooperates with the display unit 10 to form a touch screen. When a page of a file is displayed, the processing unit 30 detects touch signals generated by the touch panel 42 and determines touch position coordinates according to the touch signals and further determines a touch track 43 according to the touch position coordinates. The touch track 43 may be generated by a reader using, for example a stylus or their finger on the touch screen. The processing unit 30 determines whether the touch track 43 is similar to a preset symbol, displays an input box beside the touch track 43 for readers to input a notation and stores the notation in the storage unit 40 if the touch track 43 is similar to a preset symbol.

In the embodiment, the preset symbol is pre-stored in the storage unit 40, the preset symbol is

V-shaped symbol. When the touch track 43 is similar to the preset symbol, the processing unit 30 controls to displays the touch track 43 and the input box together on the display unit 10 (see FIG. 1). The processing unit 30 further replaces the touch track 43 with the notation symbol 44 on the page after the notation is stored, to remind readers that there is a notation at that position on the page.

In the embodiment, the input unit 20 also includes character buttons to facilitate reader input.

The processing unit 30 includes a detect module 31, a notation module 32 and a replacing module 33. The detect module 31 is electrically connected to the touch panel 42 to detect touch operations, generates touch signals and further determines touch point coordinates to determine the touch track 43 corresponding to the touch operation according to the touch signals. The detect module 31 further determines whether the touch track 43 is similar to the preset symbol, for example, the detect module 31 determines the touch track 43 is similar to the preset symbol if the touch track 43 on a page is approximately V-shaped and the angle of the V-shaped track does not exceed a preset value according to the touch point coordinates and the order of the coordinates. The detect module 31 generates a notation signal and transmits the notation signal to the notation module 32 if the touch track 43 is similar to the preset symbol.

The notation module 32 controls to display an input box at the vertex of the V-shaped track on the page, and the reader then inputs the notation content, the notation module 32 stores the notation content in the storage unit 40, and further generates a replacing signal. The notation content is stored and associated with the position of the vertex of the V-shaped track in the page.

The replacing module 33 replaces the V-shaped track with the notation symbol 44 at the vertex of the V-shaped track. The notation symbol 44 is stored and associated with its position, and shown at the position whenever the page is displayed. Readers can click the notation symbol 44 to view the notation content.

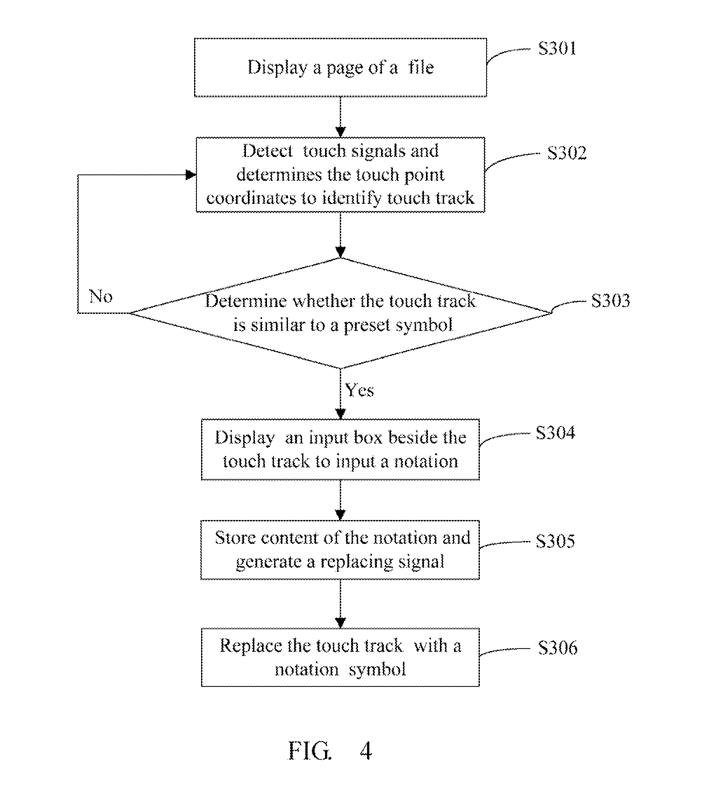

Referring to the FIG. 4, a notation-adding method is applied in the electronic reader 100 in accordance with an exemplary embodiment.

In step S301, the electronic reader 100 controls to display a page of a file.

In step S302, a detect module 31 of the electronic reader 100 detects touch signals and determines the touch point coordinates to identify touch track 43 according to the touch signals.

In step S303, the detect module 31 determines whether the touch track 43 is similar to a preset symbol. In the embodiment, the detect module 31 determines the touch track 43 is similar to the preset symbol if the touch track 43 on a page is approximately V-shaped and the angle of the V-shaped track does not exceed a preset value according to the touch point coordinates and the order of the coordinates.

In step S304, a notation module 32 of the electronic reader 100 controls to display an input box beside the touch track 43 for readers to input a notation if the touch track 43 is similar to the preset symbol. Otherwise, the procedure returns to the step S302.

In step S305, the notation-adding module 32 stores content of the notation in a storage unit 40 and generates a replacing signal. In the embodiment, the content of the notation is stored associated with the position of the vertex of the V-shaped track in the page.

In step S306, a replacing module 33 of the electronic reader 100 replaces the touch track 43 with the notation symbol 44, the notation symbol 44 is shown at the vertex position of the V-shaped track.

In the embodiment, the notation symbol 44 is stored relatively to the position of the vertex of the V-shaped track and shown at the position of the vertex of the V-shaped track each time the page is opened.

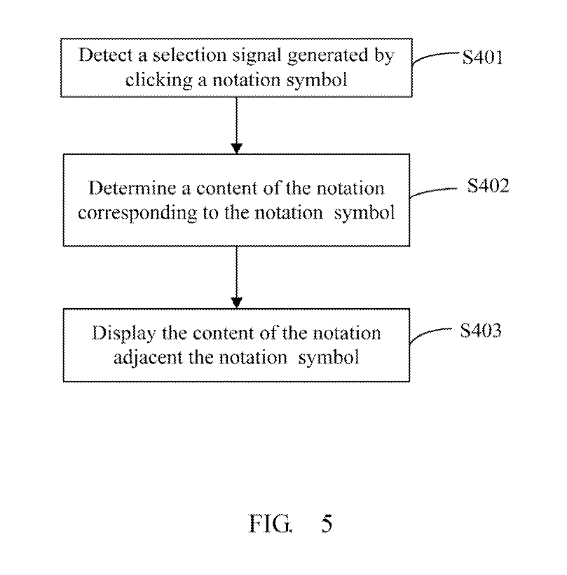

Referring to the FIG. 5, in the embodiment, a method for showing content of a notation is applied in the electronic reader 100.

In the step S401, the detect module 31 detects a selection signal generated by clicking the notation symbol 44.

In the step S402, the notation module 32 determines content of the notation corresponding to the notation symbol 44.

In the step S403, the notation module 32 controls to display the content of the notation adjacent the notation symbol 44.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic reader, comprising:
an input unit configured to generate touch signal and selection signal in response to user inputs;
a storage unit configured to store a file, a preset symbol and notation symbol; and
a processing unit configured to:
control to display a page of the file;
detect touch signals and determine touch point coordinates for determining a touch track on the page according to the touch signals;
determine whether the touch track is analogous to the preset symbol;
control to display an input box beside the touch track to receive content of a notation if the touch track is analogous to the preset symbol; and
store the content of the notation in the storage unit and show the notation symbol at a vertex position of the touch track to replace the touch track to indicate the notation.

2. The electronic reader as claimed in claim 1, wherein the preset symbol is a V-shaped symbol.

3. The electronic reader as described in claim 2, wherein the processing unit determines the touch track is similar to the preset symbol if the touch track on a page is approximately V-shaped track and the angle of the V-shaped track does not exceed a preset value according to the touch point coordinates and the order of the coordinates.

4. The electronic reader as described in claim 3, wherein the content of the notation is stored associated with the position of the vertex of the V-shaped track on the page.

5. The electronic reader as described in claim 3, wherein the notation symbol indicating the notation is stored in association with the position of the vertex of the V-shaped track and shown at the position of the vertex of the V-shaped track each time the page is opened.

6. The electronic reader as described in claim 1, wherein the input unit is a touch panel, the touch panel cooperates with a display unit to form a touch screen for receiving user inputs.

7. The electronic reader as described in claim 1, wherein the input unit also comprises character buttons to facilitate the readers to input the notation.

8. A notation-adding method applied in an electronic reader, comprising:
controlling to display a page of a file;
detecting touch signals and determine touch point coordinates for determining a touch track on the page according to the touch signals;
determining whether the touch track is analogous to a preset symbol;
controlling to display an input box beside the touch track for receiving content of a notation if the touch track is similar to the preset symbol;
storing the content of the notation in the storage unit and showing the notation symbol at a vertex position of the touch track to replace the touch track to indicate the notation.

9. The method as described in claim 8, wherein the touch track is taken as being analogous to the preset symbol if the touch track is approximately V-shaped and the angle of the V-shaped touch track does not exceed a preset value according to the touch point coordinates and the order of the coordinates.

10. The method as described in claim 8, further comprising:
forming a first relationship between the content of the notation and a vertex coordinate of the touch track; and
forming a second relationship between the notation symbol and the position of the vertex of the touch track.

11. The method as described in claim 8, further comprising:
detecting a selection signal generated by clicking the notation symbol;
determining the content of the notation corresponding to the notation symbol; and
controlling to display the content of notation adjacent the notation symbol.
